(19) United States
(12) Patent Application Publication
(10) Pub. No.: US 2024/0340723 A1
(43) Pub. Date: Oct. 10, 2024

(54) UPLINK TRANSMISSIONS AND RECEPTIONS FOR RACH-LESS HANDOVER

(71) Applicant: Samsung Electronics Co., Ltd., Suwon-si (KR)

(72) Inventors: Carmela Cozzo, San Diego, CA (US); Shiyang Leng, Allen, TX (US)

(21) Appl. No.: 18/615,921

(22) Filed: Mar. 25, 2024

Related U.S. Application Data
(60) Provisional application No. 63/458,052, filed on Apr. 7, 2023.
(60) Provisional application No. 63/559,655, filed on Feb. 29, 2024.

(51) Int. Cl. H04W 36/00; H04B 17/318; H04W 72/1268; H04W 72/232

(52) U.S. Cl. CPC H04W 36/00725; H04B 17/328; H04W 72/1268; H04W 72/232

(57) ABSTRACT

Methods and apparatuses for uplink transmissions and receptions for random access channel (RACH)-less handover. A method includes receiving information for a first configuration for RACH-less handover procedure in a system information block (SIB) from a source cell, a first set of synchronization signal (SS) and physical broadcast channel (PBCH) (SS/PBCH) block indexes, a physical uplink shared channel (PUSCH) for a transmission of the PUSCH on a target cell, and a number of repetitions of the transmission of the PUSCH on the target cell. The method further includes determining a spatial setting for the transmission of the PUSCH and transmitting the PUSCH with the number of repetitions using the spatial setting on the target cell.

### CROSS-REFERENCE TO RELATED APPLICATION AND CLAIM OF PRIORITY

This application claims priority under 35 U.S.C. § 119 (e) to U.S. Provisional Patent Application No. 63/458,052 filed on Apr. 7, 2023 and U.S. Provisional Patent Application No. 63/559,655 filed on Feb. 29, 2024. The above-identified provisional patent application is hereby incorporated by reference in its entirety.

### TECHNICAL FIELD

The present disclosure relates generally to wireless communication systems and, more specifically, relates to uplink (UL) transmissions and receptions for random access channel (RACH)-less handover procedures.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to RACH-less handover procedures for UL.

In an embodiment, a user equipment (UE) is provided. The UE includes a transceiver configured to receive information for a first configuration for RACH-less handover procedure in a system information block (SIB) from a source cell, a first set of synchronization signal (SS) and physical broadcast channel (PBCH) (SS/PBCH) block indexes, a physical uplink shared channel (PUSCH) for a transmission of the PUSCH on a target cell, and a number of repetitions of the transmission of the PUSCH on the target cell. The UE further includes a processor operably coupled to the transceiver. The processor is configured to determine a spatial setting for the transmission of the PUSCH. The transceiver is further configured to transmit the PUSCH with the number of repetitions using the spatial setting on the target cell.

In another embodiment, a base station (BS) is provided. The BS includes a transceiver configured to transmit information for a first configuration for RACH-less handover procedure in a SIB from a source cell, a first set of SS/PBCH block indexes, a PUSCH for a reception of the PUSCH on a target cell, and a number of repetitions of the reception of the PUSCH on the target cell. The BS further includes a processor operably coupled to the transceiver. The processor is configured to determine a spatial setting for the reception of the PUSCH. The transceiver is further configured to receive the PUSCH with the number of repetitions using the spatial setting on the target cell.

In yet another embodiment, a method is provided. The method includes receiving information for a first configuration for RACH-less handover procedure in a SIB from a source cell, a first set of SS/PBCH block indexes, a PUSCH for a transmission of the PUSCH on a target cell, and a number of repetitions of the transmission of the PUSCH on the target cell. The method further includes determining a spatial setting for the transmission of the PUSCH and transmitting the PUSCH with the number of repetitions using the spatial setting on the target cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A-4B illustrate example wireless transmit and receive paths according to embodiments of the present disclosure;

FIG. 5 illustrates a block diagram of an example transmitter structure using orthogonal frequency division multiplexing (OFDM) according to embodiments of the present disclosure;

FIG. 6 illustrates a block diagram of an example receiver structure using OFDM according to embodiments of the present disclosure;

FIGS. 7A and 7B illustrate examples of satellite coverages in a NTN according to various embodiments of the present disclosure;

FIG. 8 illustrates a UE procedure for RACH-less handover to a target satellite according to this disclosure;

FIG. 9 illustrates a UE procedure for RACH-less handover for a first uplink transmission with repetitions scheduled by a DCI format received in a target cell according to various embodiments of the present disclosure;

FIG. 10 illustrates a UE procedure for RACH-less handover for a first uplink transmission with repetitions in a target cell scheduled by a configured grant various embodiments of the present disclosure;

FIG. 11 illustrates a UE procedure for RACH-less handover for a first PUCCH transmission with repetitions in a target cell according to various embodiments of the present disclosure; and

FIG. 12 an example method performed by a UE in a wireless communication system according to embodiments of the present disclosure.

### DETAILED DESCRIPTION

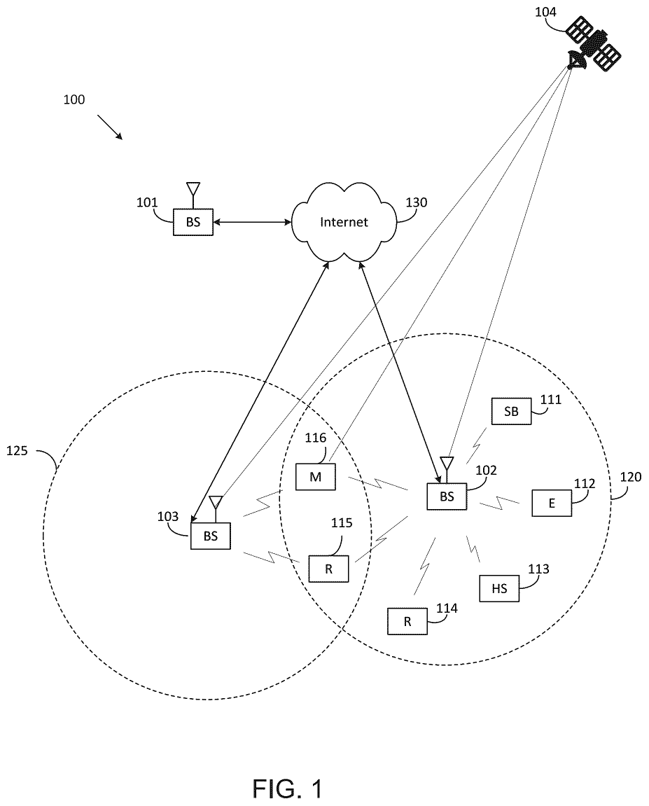

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.3.0, “NR; Physical channels and modulation” (REF1); 3GPP TS 38.212 v17.3.0, “NR; Multiplexing and Channel coding” (REF2); 3GPP TS 38.213 v17.3.0, “NR; Physical Layer Procedures for Control” (REF3); 3GPP TS 38.214 v17.3.0, “NR; Physical Layer Procedures for Data” (REF4); 3GPP TS 38.321 v17.2.0, “NR; Medium Access Control (MAC) protocol specification” (REF5); and 3GPP TS 38.331 v17.2.0, “NR; Radio Resource Control (RRC) Protocol Specification” (REF6).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in obit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. Various of the UEs (e.g., as depicted by UE 116) may be capable of at least some direct communication and/or localization with the communication satellite(s) 104, for example, to receive positional information or coordinates.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof to facilitate uplink transmissions for RACH-less handover procedures. In certain embodiments, one or more of the BSs 101-103 include circuitry, programing, or a combination thereof to facilitate uplink transmissions for RACH-less handover procedures.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

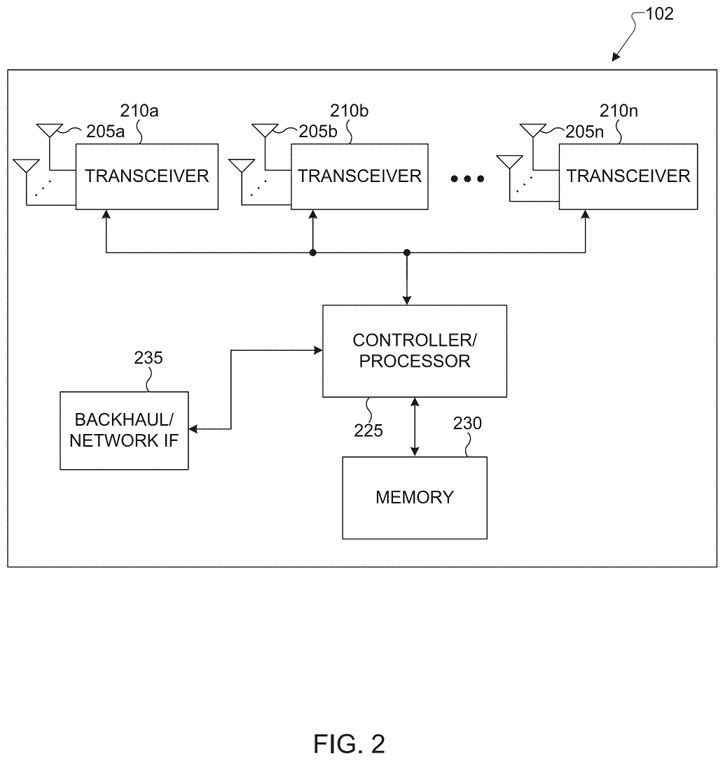

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support radio link monitoring in FD systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs. In embodiments of this disclosure, the gNB 102 may support or receive uplink transmissions for RACH-less handover procedures.

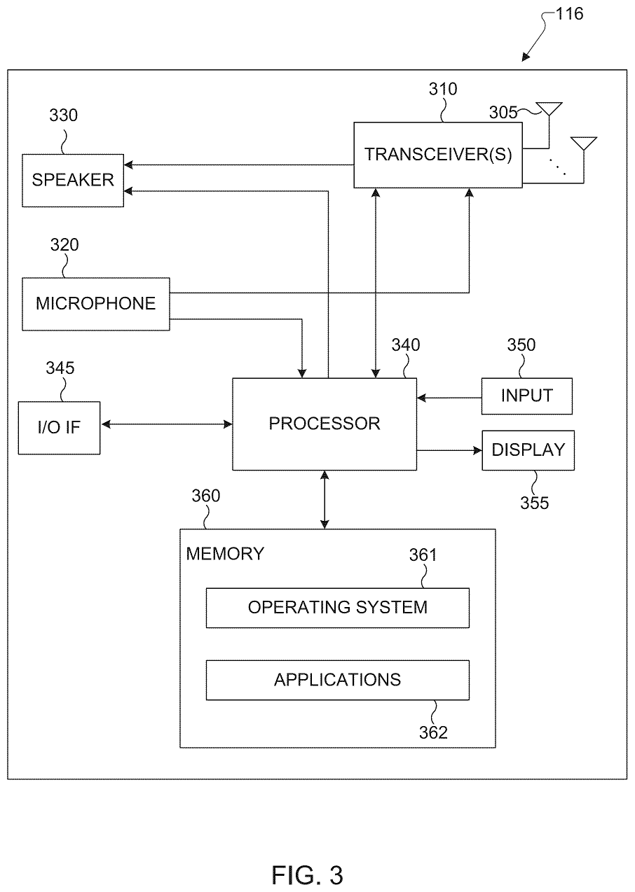

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data). In embodiments of this disclosure, the gNB 102 may support and facilitate uplink transmissions for RACH-less handover procedures, via the antenna 305.

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, as discussed in greater detail below, the processor 340 may execute processes to perform uplink transmissions for RACH-less handover procedures. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

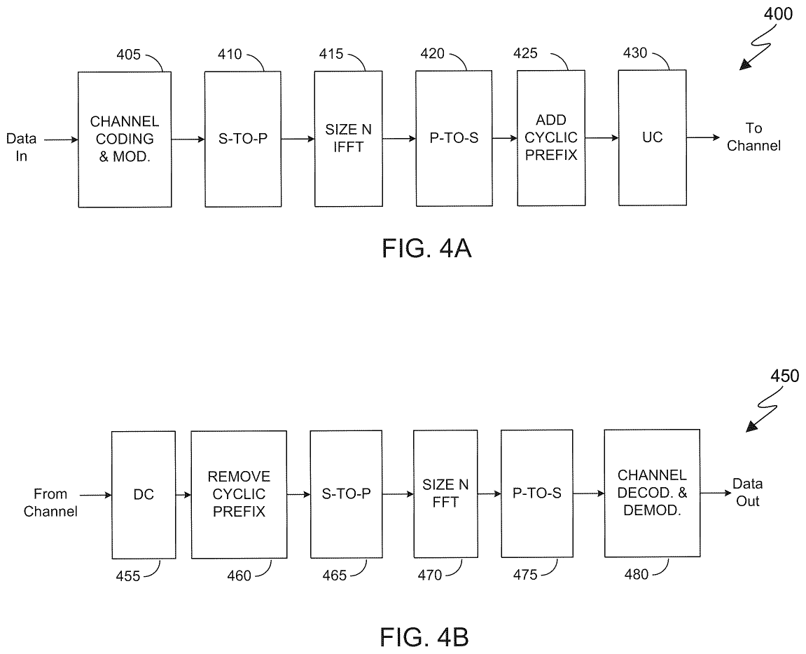

FIGS. 4A and 4B illustrate example wireless transmit and receive paths according to this disclosure. In the following description, a transmit path 400 may be described as being implemented in an gNB (such as gNB 102), while a receive path 450 may be described as being implemented in a UE (such as UE 116). However, it will be understood that the receive path 450 can be implemented in an gNB and that the transmit path 400 can be implemented in a UE. The transmit path 400 and the receive path 450 may each support uplink transmissions for RACH-less handover procedures in accordance with embodiments of this disclosure.

The transmit path 400 includes a channel coding and modulation block 405, a serial-to-parallel (S-to-P) block 410, a size N Inverse Fast Fourier Transform (IFFT) block 415, a parallel-to-serial (P-to-S) block 440, an add cyclic prefix block 445, and an up-converter (UC) 430. The receive path 450 includes a down-converter (DC) 455, a remove cyclic prefix block 460, a serial-to-parallel (S-to-P) block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 440 converts (such as multiplexes) the parallel time-domain output symbols from the size N IFFT block 415 in order to generate a serial time-domain signal. The add cyclic prefix block 445 inserts a cyclic prefix to the time-domain signal. The up-converter 430 modulates (such as up-converts) the output of the add cyclic prefix block 445 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103. In embodiments, the transmit path 400 and the receive path 450 are each configured to support uplink transmissions for RACH-less handover procedures in accordance with this disclosure.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 4, 3, 4, or the like) for DFT and IDFT functions, while the value of the variable N may be any integer number that is a power of two (such as 1, 4, 4, 8, 16, or the like) for FFT and IFFT functions.

Although FIGS. 4A and 4B illustrate examples of wireless transmit and receive paths, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A PDCCH transmission is over a number of control channel elements (CCEs) from a predetermined set of numbers of CCEs referred to as CCE aggregation level. A PDSCH transmission is scheduled by a DCI format or is semi-persistently scheduled (SPS) as configured by higher layers and activated by a DCI format. A PDSCH reception by a UE provides one or more transport blocks (TBs), wherein a TB is associated with a hybrid automatic repeat request (HARQ) process that is indicated by a HARQ process number field in a DCI format scheduling the PDSCH reception or activating a SPS PDSCH reception and a redundancy version (RV) that is indicated by a RV field in the DCI format when incremental redundancy is used for encoding the TB. A TB transmission can be an initial one or a retransmission as identified by a new data indicator (NDI) field in the DCI format scheduling a PDSCH reception that provides a TB retransmission for a given HARQ process number.

A gNB transmits one or more of multiple types of RS including channel state information RS (CSI-RS) and demodulation RS (DM-RS)—see also REF 1. A CSI-RS is primarily intended for UEs to perform measurements and provide channel state information (CSI) to a gNB. For channel measurement or for time tracking, non-zero power CSI-RS (NZP CSI-RS) resources are used. For interference measurement reports (IMRs), CSI interference measurement (CSI-IM) resources are used (see also REF 3). The CSI-IM resources can also be associated with a zero power CSI-RS (ZP CSI-RS) configuration. A UE can determine CSI-RS reception parameters through DL control signaling or higher layer signaling, such as radio resource control (RRC) signaling from a gNB (see also REF 5). A DM-RS is typically transmitted only within a BW of a respective PDCCH or PDSCH and a UE can use the DM-RS to demodulate data or control information.

A UE typically monitors multiple candidate locations for respective potential PDCCH receptions to decode multiple DCI formats in a slot, for example as described in REF 3. A DCI format includes cyclic redundancy check (CRC) bits in order for the UE to confirm a correct detection of the DCI format. A DCI format type is identified by a radio network temporary identifier (RNTI) that scrambles the CRC bits (see also REF 2).

For a DCI format scheduling a PDSCH or a PUSCH to a single UE, the RNTI can be a cell RNTI (C-RNTI), or a configured scheduling RNTI (CS-RNTI), or an MCS-C-RNTI and serves as a UE identifier. In the following, for brevity, only the C-RNTI will be referred to when needed. A UE typically receives/monitors PDCCH for detections of DCI formats with CRC scrambled by a C-RNTI according to a UE-specific search space (USS). For a DCI format 0_0 and a DCI format 1_0 that schedule PUSCH transmissions and PDSCH receptions, respectively, to a UE, the UE can additionally be configured to monitor corresponding PDCCH according to common search space (CSS). For a DCI format 0_1 and a DCI format 0_2 that are mainly used to schedule PUSCH transmissions or for a DCI format 1_1 and a DCI format 1_2 that are mainly used to schedule PDSCH receptions, the UE monitors corresponding PDCCH according to a USS. PDCCH monitoring implies reception of PDCCH candidates and decoding of potential DCI formats.

For a DCI format scheduling a PDSCH conveying system information (SI), the RNTI can be an SI-RNTI. For a DCI format scheduling a PDSCH providing a random access response (RAR), the RNTI can be an RA-RNTI. For a DCI format scheduling a PDSCH providing paging information, the RNTI can be a P-RNTI. A UE monitors PDCCH for these DCI formats according to a corresponding CSS on a primary cell. There are also a number of other RNTIs provided to a UE by UE-specific RRC signaling and are associated with DCI formats providing various control information and have corresponding PDCCHs that a UE monitors according to a Type-3 CSS on the primary cell or on a secondary cell. Such DCI formats include a DCI format 2_0 providing a structure of a slot in term of DL, UL or flexible/reserved symbols over a number of slots, a DCI format 2_2 providing transmit power control (TPC) commands for PUSCH or PUCCH transmissions, a DCI format 2_3 providing TPC commands for SRS transmissions and also potentially triggering a SRS transmission on a number of cells, and so on, and a corresponding CSS is referred to as Type3-PDCCH CSS.

UL signals also include data signals conveying information content, control signals conveying UL control information (UCI), DM-RS associated with data or UCI demodulation, phase-tracking RS (PT-RS) used for phase tracking in symbols of a PUSCH, and sounding RS (SRS) enabling a gNB to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of symbols in a slot including one symbol. When a UE simultaneously transmits data information and UCI, the UE can multiplex both in a PUSCH or, depending on a UE capability, transmit both a PUSCH with data information and a PUCCH with UCI at least when the transmissions are on different cells.

UL RS includes DM-RS, PT-RS, and SRS. DM-RS is typically transmitted within a BW of a respective PUSCH or PUCCH. A gNB can use a DM-RS to demodulate information in a respective PUSCH or PUCCH. SRS is transmitted by a UE to provide a gNB with an UL CSI and, for a TDD system, to also provide a PMI for DL transmission. Further, as part of a random access procedure or for other purposes, a UE can transmit a physical random access channel (PRACH).

UCI includes hybrid automatic repeat request acknowledgement (HARQ-ACK) information, indicating correct or incorrect decoding of TBs or of code block groups (CBGs) in a PDSCH, scheduling request (SR) indicating whether a UE has data in its buffer to transmit, and CSI reports enabling a gNB to select appropriate parameters for PDSCH/TB or PDCCH/DCI format transmissions to a UE. A UE transmits a PUCCH on a primary cell of a cell group. HARQ-ACK information is either a positive acknowledgement (ACK) when a TB decoding is correct or a negative acknowledgement (NACK) when a TB decoding is incorrect. An ACK can be represented by a binary ‘1’ value and a NACK can be represented by a binary ‘0’ value.

DL receptions and UL transmissions by a UE can be configured to occur in a corresponding DL bandwidth part (BWP) and UL BWP. A DL/UL BWP is smaller than or equal to a DL/UL bandwidth of a serving cell. DL transmissions from a gNB and UL transmissions from a UE can be based on an orthogonal frequency division multiplexing (OFDM) waveform including a variant using DFT precoding that is known as DFT-spread-OFDM (see also REF 1).

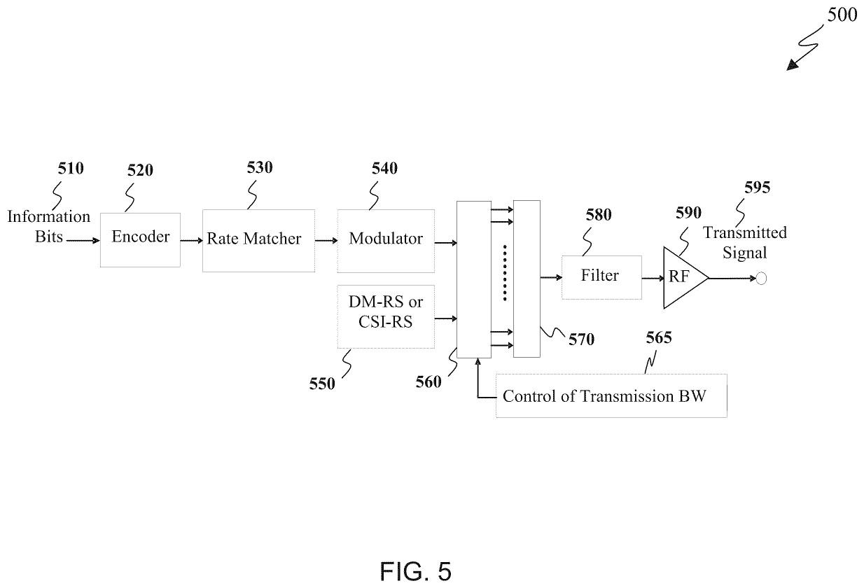

FIG. 5 illustrates a block diagram of an example transmitter structure 500 using OFDM according to this disclosure. The embodiment of the example transmitter structure 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the example transmitter structure 500.

Information bits, such as DCI bits or data bits 510, are encoded by encoder 520, rate matched to assigned time/frequency resources by rate matcher 530, and modulated by modulator 540. Subsequently, modulated encoded symbols and DM-RS or CSI-RS 550 are mapped to SCs 560 by SC mapping unit 565, an inverse fast Fourier transform (IFFT) is performed by filter 570, a cyclic prefix (CP) is added by CP insertion unit 580, and a resulting signal is filtered by filter 590 and transmitted by a radio frequency (RF) unit 595. In embodiments, the transmitter structure 500 may be used to support enhancements for CSI measurement and reporting with network adaptation.

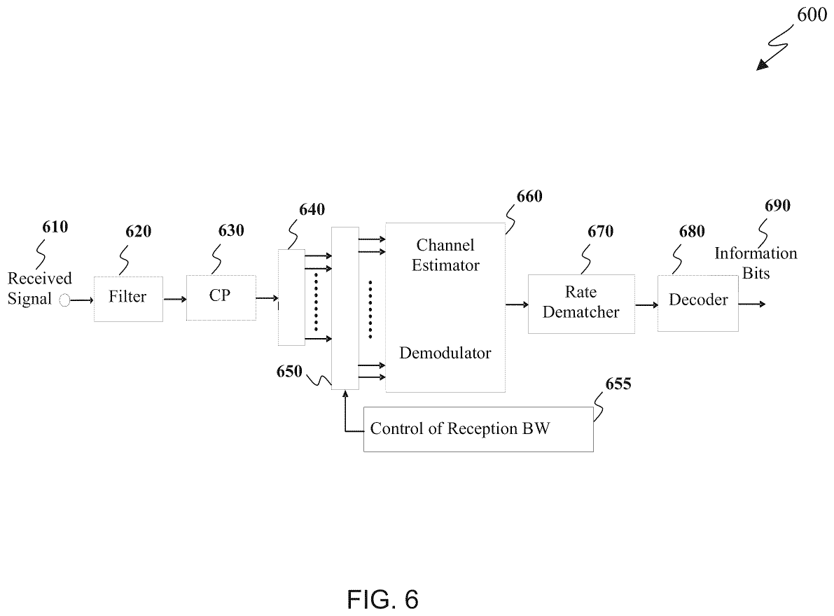

FIG. 6 illustrates a block diagram of an example receiver structure 600 using OFDM according to this disclosure. The embodiment of the example receiver structure 600 illustrated in FIG. 6 is for illustration only. One or more of the components illustrated in FIG. 5 can be implemented in specialized circuitry configured to perform the noted functions or one or more of the components can be implemented by one or more processors executing instructions to perform the noted functions. FIG. 6 does not limit the scope of this disclosure to any particular implementation of the example receiver structure 600.

A received signal 610 is filtered by filter 620, a CP removal unit removes a CP 630, a filter 640 applies a fast Fourier transform (FFT), SCs de-mapping unit 650 de-maps SCs selected by BW selector unit 655, received symbols are demodulated by a channel estimator and a demodulator unit 660, a rate de-matcher 670 restores a rate matching, and a decoder 680 decodes the resulting bits to provide information bits 690. In embodiments, the receiver structure 600 may be used to support enhancements for CSI measurement and reporting with network adaptation.

A UE (e.g., UE 114) multiplexes HARQ-ACK information associated with DCI formats, such as DCI format scheduling PDSCH receptions, in a PUCCH that the UE transmits in a slot indicated by a value of PDSCH-to-HARQ feedback timing indicator field in a last DCI format associated with the HARQ-ACK information and indicating the slot. A value K1 of the field can be from a set of slot timing values K1 or can be indicated by higher layers as in case of a SPS PDSCH receptions as described in REF3. When a UE (e.g., UE 114) has received UE-specific RRC signaling providing PUCCH resource sets, the UE determines a PUCCH resource set based on a UCI payload to multiplex in a PUCCH and determines a PUSCH resource within the PUCCH resource set based on a PUCCH resource index (PRI) in the DCI format.

A random access (RA) procedure can be initiated to fulfill one of the following purposes: establish RRC connection (to go from RRC_IDLE to RRC_CONNECTED), re-establish RRC connection after radio link failure (RLF), on-demand system information (SI) request, UL synchronization, scheduling request (SR), positioning, or link recovery—also known as beam failure recovery (BFR). Physical random access procedure is triggered upon request of a PRACH transmission by higher layers or by a PDCCH order. Random access (RA) can operate in two modes: (i) contention-based random access (CBRA) where UEs within a serving cell can share same RA resources and there is therefore a possibility of collision among RA attempts from different UEs, and (ii) contention-free random access (CFRA) where a UE has dedicated RA resources that are indicated by a serving gNB and may not be shared with other UEs so that RA collisions can be avoided.

A 4-step random access procedure, also known as a Type-1 L1 random access procedure includes step-1: UE transmission of a Physical Random Access Channel (PRACH) preamble (Msg1); step-2: gNB transmission of Random Access Response (RAR) message with a PDCCH/PDSCH (Msg2); step-3: UE transmission of a contention resolution message and when applicable, the transmission of a PUSCH scheduled by a RAR UL grant (Msg3); and step-4: gNB transmission of a contention resolution message (Msg4). An alternative RA procedure can include only two steps, referred to herein as 2-step RA or a Type-2 L1 random access procedure. In two step RA, Msg1 and Msg3 are combined into a MsgA transmission and Msg2 and Msg4 are combined into a MsgB reception. MsgA combines a PRACH preamble transmission in a random access channel (RACH) occasion (RO) along with a PUSCH transmission in a PUSCH occasion (PO).

Prior to initiation of the physical random access procedure, Layer 1 receives from higher layers a set of SS/PBCH block indexes and provides to higher layers a corresponding set of RSRP measurements. Layer 1 receives the configuration of PRACH transmission parameters (PRACH preamble format, time resources, and frequency resources for PRACH transmission). UE transmits a PRACH using the selected PRACH format with the transmission power determined depending on whether the PRACH transmission is triggered upon request by higher layers or is in response to a detection of a PDCCH order by the UE, and depending on the action associated to the PDCCH order.

A RAR is a PDCCH/PDSCH transmission that the UE receives on a DL BWP of a SpCell: the initial DL BWP of the PCell/SpCell for the case of initial access, i.e., (re-) establishing RRC connection, or the active DL BWP (with the same BWP-index as the active UL BWP) of an SpCell for other random access triggers except for initial access. If the active DL BWP index (of the SpCell) is not equal to active UL BWP index (of the serving cell), then switch the active DL BWP to one with the same BWP index. The SCS for PDCCH in RAR message is the SCS for Type1-PDCCH CSS set. The SCS for any future PDSCH is also the same SCS as that for PDSCH in RAR, unless the UE is configured an SCS. The PDCCH for RAR is a DCI format 1_0 that the UE monitors, during a certain configured time window, in Type1-PDCCH common search space (CSS) set of the SpCell identified by the RA-RNTI or, for the case of BFR with CFRA, in the search space indicated by recoverySearchSpaceId of the SpCell identified by the C-RNTI. The PDSCH part of RAR contains the gNB response.

For contention-free random access (CFRA) based BFR, receiving a PDCCH during the time window and in the indicated search space of SpCell and addressed correctly to the C-RNTI is sufficient to consider RAR to be successful. For other cases, such as contention-based random access (CBRA) and SI request, RAR is successful if (i) a PDCCH in the Type1-PDCCH common search space (CSS) set of the SpCell is received during the configured time window and is addressed to the RA-RNTI; and (ii) the corresponding PDSCH is correctly decoded; and (iii) the MAC RAR contained in PDSCH part of RAR contains a random access preamble ID (RAPID); and (iv) the RAPID in MAC RAR matches the preamble selected and transmitted by the UE in Msg1. Then, the UE, for the serving cell where PRACH preamble/Msg1 was transmitted, applies the TA to adjust/correct the timing between UE and gNB, stores TC-RNTI for use in future transmission, and processes the RAR UL grant to transmit Msg3.

For CFRA or SI request, a correct reception of Msg2/RAR is the last step for the random access procedure. For CBRA, multiple UEs may have used the same preamble, and further steps are needed to resolve the contention. Furthermore, for the case of random access before RRC_CONNECTED state (i.e., for initial access), UE and gNB need to exchange further information to set up the connection: an uplink PUSCH transmission (Msg3) for contention resolution request and possibly also for connection setup request, and a downlink transmission (Msg4) for contention resolution response and possibly for connection setup response. The contention resolution (and connection set up, if applicable) is considered successful if the UE receives Msg4 within a certain time window after transmission of Msg3 and, for the case that the UE does not have a C-RNTI yet, if the contention resolution ID in Msg4 matches the ID that the UE transmitted in Msg3. Otherwise, the random access channel (RACH) attempt is considered unsuccessful, and the UE needs to make another RACH attempt, unless the configured maximum number of RACH attempts have been already exhausted, in which case the entire random access procedure is declared as unsuccessful.

In response to a PUSCH transmission scheduled by a RAR UL grant when a UE (e.g., UE 113) has not been provided a C-RNTI, the UE attempts to detect a DCI format 1_0 with CRC scrambled by a corresponding TC-RNTI scheduling a PDSCH that includes a UE contention resolution identity. In response to the PDSCH reception with the UE contention resolution identity, the UE transmits HARQ-ACK information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH processing time for UE processing capability 1 when additional PDSCH DM-RS is configured.

When the UE (e.g., UE 113) transmits a PUCCH that provides HARQ-ACK information in response to the PDSCH reception scheduled by a DCI format 1_0 with CRC scrambled by a TC-RNTI, a PUCCH resource a PUCCH resource set is provided by pucch-ResourceCommon through an index to a row of a table for transmission of HARQ-ACK information on PUCCH in an initial UL BWP. The table includes sixteen rows corresponding to sixteen resources, each corresponding to a PUCCH format, a first symbol, a duration, a PRB offset, and a cyclic shift index set for a PUCCH transmission. If the UE provides HARQ-ACK information in a PUCCH transmission in response to detecting a DCI format scheduling a PDSCH reception or having associated HARQ-ACK information without scheduling a PDSCH reception, the UE determines a PUCCH resource with index r_{PUCCH}, 0≤r_{PUCCH}≤15, as r_{PUCCH}=└2·n_{CCE,0}/N_{CCE}┘+2·Δ_{PRI}, where N_{CCE} is a number of CCEs in a CORESET of a PDCCH reception with N_{CCE} the DCI format, n_{CCE,0} is the index of a first CCE for the PDCCH reception, and Δ_{PRI} is a value of the PUCCH resource indicator field in the DCI format.

When detecting a DCI format in response to a PUSCH transmission scheduled by a RAR UL grant, or corresponding PUSCH retransmission scheduled by a DCI format 0_0 with CRC scrambled by a TC-RNTI provided in the corresponding RAR message, the UE may assume the PDCCH carrying the DCI format has same DM-RS antenna port quasi co-location properties as for a SS/PBCH block the UE used for PRACH association regardless of whether or not the UE is provided TCI-State for the CORESET where the UE receives the PDCCH with the DCI format.

In the following, unless otherwise explicitly noted, providing a parameter value by higher layers includes providing the parameter value by a system information block (SIB), such as a SIB1, or by a common RRC signaling, or by UE-specific RRC signaling. The following descriptions may discuss that a satellite implements a transparent payload, but these descriptions are also directly applicable to regenerative payloads. The following descriptions and embodiments for satellites can be also directly applicable or adapted for any aerial platform. Throughout this disclosure the terms source or target satellite and source or target gNB are used interchangeably to refer to any component (or collection of components) configured to provide remote terminals with wireless access to a network.

The following descriptions and embodiments for a non-terrestrial network (NTN) are also directly applicable to a terrestrial network (TN), and vice versa. Functionalities of a satellite can be same as the functionalities of a gNB in TN, or can be adapted taking into account that a satellite footprint of a LEO satellite changes due to the movement of the satellite respect to earth. The satellite footprint of a GEO satellite is fixed, similar to a cell in a TN.

Ensuring a reception reliability for UL channels is particularly challenging in NTN compared with a TN due to the limited link-budget associated with a larger path-loss. A NTN is a network using RF resources on board satellites or unmanned aerial service (UAS) platforms (e.g., satellite 104). A NTN includes satellites that can be Geostationary Earth Orbiting (GEO) satellites served by one or several sat-gateways that are deployed across the satellites targeted coverage or Low Earth Orbit (LEO) satellites served successively by one or several satellite-gateways at a time, a radio link between a sat-gateway and the satellite or UAS platform, a radio link between the UE and the satellite or UAS platform. A satellite or UAS platform may implement either a transparent or a regenerative (with on board processing) payload. The satellite or UAS platform typically generates several beams over a given service area bounded by its field of view which depends on the on-board antenna diagram and elevation angle. The footprint of a beam has an elliptic shape and is considered as a cell in terrestrial networks.

3GPP (Third-Generation Partnership Project) has developed technical specifications and standards to define the new 5G radio-access technology, known as 5G NR (New Radio). In Release 17 specification, the non-terrestrial network (NTN) is supported as a vertical functionality by 5G NR. A Non-Terrestrial Network (NTN) providing non-terrestrial NR access to the UE by means of an NTN payload, e.g., a satellite 104 operating in an NTN, and an NTN Gateway. The NTN payload transparently forwards the radio protocol received from the UE (via the service link, i.e., wireless link between the NTN payload and UE) to the NTN Gateway (via the feeder link, i.e., wireless link between the NTN Gateway and the NTN payload) and vice-versa. Considering its capabilities of providing wide coverage and reliable service, NTN is envisioned to ensure service availability and continuity ubiquitously. For instance, NTN can support communication services in unserved areas that cannot be covered by conventional terrestrial networks, in underserved areas that are experiencing limited communication services, for devices and passengers on board moving platforms, and for future railway/maritime/aeronautical communications, etc. To support NTN in 5G NR, various features need to be introduced or enhanced to accommodate the nature of radio access to NTN that is different to terrestrial networks (TN) such as large cell coverage, long propagation delay, and non-static cell/satellite.

In NTN, the NTN payload can be GSO, i.e. earth-centered orbit at approximately 35786 kilometers above Earth's surface and synchronized with Earth's rotation, or NGSO, i.e. Low Earth Orbit (LEO) at altitude approximately between 300 km and 1500 km and Medium Earth Orbit (MEO) at altitude approximately between 7000 km and 25000 km. Depending on different NTN payloads, three types of service links are supported: earth-fixed, provisioned by beam(s) continuously covering the same geographical areas all the time (e.g., the case of GSO satellites); quasi-earth-fixed, provisioned by beam(s) covering one geographic area for a limited period and a different geographic area during another period (e.g., the case of NGSO satellites generating steerable beams); and earth-moving, provisioned by beam(s) whose coverage area slides over the Earth surface (e.g., the case of NGSO satellites generating fixed or non-steerable beams). With NGSO satellites, the gNB can provide either quasi-earth-fixed cell coverage or earth-moving cell coverage, while gNB operating with GSO satellite can provide earth fixed cell coverage. Due to different properties of GSO and NGSO, different types of cells can be supported in NTN: earth-fixed cells, quasi-earth-fixed cells, and earth-moving cells. For a certain type of NTN payload/cell, specific features or functionalities are desired to be supported by the UE for radio access.

For cell selection/reselection, a UE usually measures neighbor cell to search for a suitable or acceptable cell to camp on. A gNB (e.g., gNB 102) can provide configurations on neighbor cell measurement and cell (re)-selection. The configuration can contain cell re-selection information common for intra-frequency, inter-frequency and/or inter-RAT cell re-selection, cell re-selection information per frequency (i.e., information about other NR frequencies and inter-frequency neighbor cells relevant for cell reselection), as well as cell-specific cell re-selection information for intra-frequency, inter-frequency and/or inter-RAT neighbor cells.

For a UE (e.g., UE 114) in a connected state (e.g., RRC_CONNECTED), a gNB can provide a measurement configuration for a measurement object (e.g., intra-frequency or inter-frequency neighbor cells). Based on the measurement results of the UE, the gNB can prepare a handover (HO) from the current serving cell, i.e., source cell, to a target cell and trigger the HO execution by transmitting a HO command in an RRC message (e.g., RRCReconfiguration). The gNB can also prepare a conditional HO (CHO) with multiple candidate cells for the UE and transmit CHO configuration in an RRC message (e.g., RRCReconfiguration) to trigger the CHO evaluation.

When a HO is configured, the UE accesses the target cell via RACH following a contention-free procedure using a dedicated RACH preamble or following a contention-based procedure if dedicated RACH preambles are not available, and the UE uses the dedicated preamble until the handover procedure is finished (successfully or unsuccessfully). In NTN, due to the large distance between a UE (e.g., UE 114) and a gNB (e.g., gNB 102), HO delay and interruption caused by message exchanges between a UE and a gNB can be large, and due to the large size of an NTN cell, a large number of UEs may need to perform HO almost at the same time for quasi-fixed cell. In order to reduce the HO delay and HO overhead, a RACH-less HO, i.e., HO without RACH, can be used in NTN. If RACH-less HO is configured, the UE accesses the target cell via the uplink grant provided to the UE in the RRC message. If the UE does not receive the uplink grant in the RRC message from the source gNB, the UE monitors the PDCCH of the target cell for dynamic scheduling. If the access towards the target cell using RACH or RACH-less procedure is not successful within a certain time, the UE may initiate a radio link failure recovery using a suitable cell.

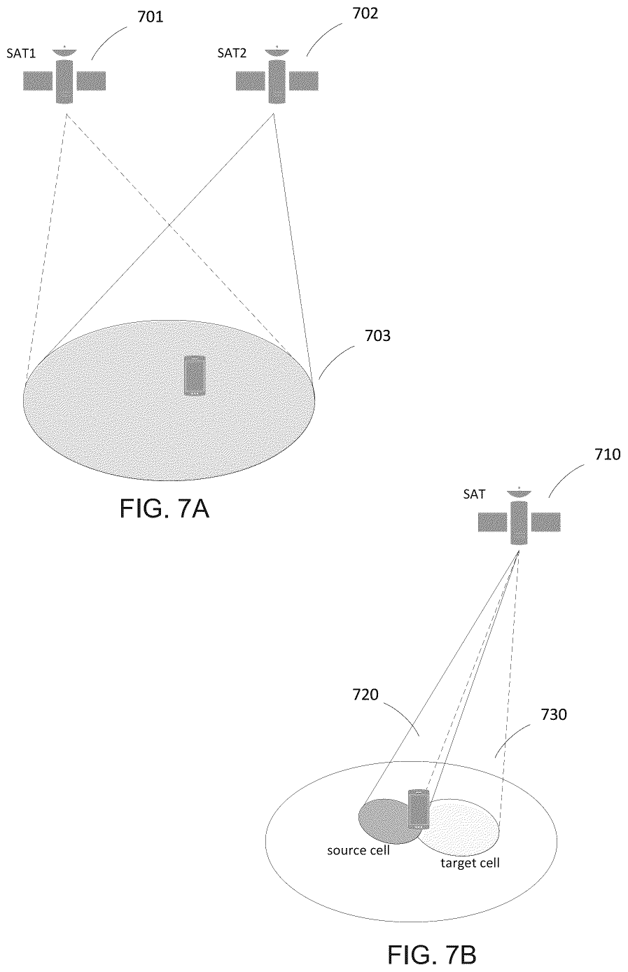

FIGS. 7A and 7B illustrate examples of satellite coverages in a NTN according to various embodiments of the present disclosure. For example, the satellites 701 and 702 may be examples of satellite 104 as part of network 100 in FIG. 1. The depiction of the satellite coverages in FIGS. 7A and 7B is for illustration only; other embodiments of could be used without departing from the scope of this disclosure.

In one example, handover from a source cell to a target cell is a satellite switching from a source satellite with a source footprint to a target satellite with a target footprint. As illustrated in FIG. 7A, a first satellite 701 and a second satellite 702 provide coverage over a same area or satellite footprint 703. Overtime the satellite footprint changes due to the relative movement of satellite and earth, and the same area has coverage from the first satellite for a first time period and from the second satellite for a second time period, and the first time period and the second time period may overlap for a time period T (referred as soft satellite switching), or may not overlap (referred as hard satellite switching). This is a typical example of NGSO scenario.

In one example, a satellite operates with a number of beams within a satellite footprint. Each beam within the satellite footprint can be regarded as a cell, and handover from a source cell to a target cell is within the satellite footprint including both source and target cells. As illustrated in FIG. 7B, a satellite 710 uses a source beam to provide coverage over a source cell 720 and a target beam to provide coverage over a target cell 730. Handover from the source cell to the target cell would happen when the satellite switches on and off corresponding beams. Whether beams within the satellite footprint can be regarded as cells can be subject to a configuration. The example of FIG. 7 is also directly applicable to terrestrial networks. For example, the gNB switches on and off beams, triggers UE beam change and provides to the UE the indication of the target beam that can be based on UE measurements reported to the gNB. For example, the gNB triggers UE serving cell change and provides information on configurations for the target cell that can be based on UE measurements reported to the gNB.

The following descriptions and embodiments are directly applicable to a RACH-less handover procedure for exemplary scenarios illustrated in FIGS. 7A and 7B.

When access towards a first target cell using a RACH-less procedure is not successful within a certain time period, a UE starts a RACH or RACH-less procedure towards a second cell that is different from the first cell. Whether the UE initiates RACH or RACH-less procedure on the second cell, is subject to a configuration, as for example provided by higher layer parameter rach-lessHO present in reconfigurationWithSync, and to RSRP measurements being larger than one or more thresholds, wherein rach-lessHO can be associated with a non-terrestrial network or with a terrestrial network or with both, RSRP measurements can be associated with SS/PBCH block receptions or with CSI-RS receptions, and RSRP threshold(s) is (are) provided by higher layer parameter, for example by rach-lessHO or by a configuration for an initial uplink transmission to a target cell or by higher layer parameters for RACH procedure or by a SIB, as for example SIB19. It is possible that the UE receives information for a first set of SS/PBCH block indexes in a first configuration and a second set of SS/PBCH indexes in a second configuration from the source cell, or from the target cell, and the second set is a different set from the first set or included in the first set. It is also possible that first and second set are received from different cells.

While access towards a target cell, also referred to as a candidate cell or candidate target cell, using RACH-less handover procedure is ongoing, or during a certain time period within which the UE is attempting to access the target cell using RACH-less handover procedure, or before completion of the ongoing RACH-less handover procedure wherein the UE, subject to a configuration, may or may not indicate to upper layers the successful completion of RACH-less handover, or the target gNB may or may not indicate to upper layers the successful completion of RACH-less handover: (i) in one example the UE can initiate a RACH procedure towards another cell different from the target cell, (ii) in one example the UE can initiate a RACH procedure towards the same target cell, (iii) in one example the UE cannot initiate a RACH procedure towards the same target cell but can initiate a RACH procedure towards another cell different from the target cell, (iv) in one example the UE cannot initiate a RACH procedure towards the same or a different cell, or a combination of the above examples. The certain time period can be the time period before a timer expiry, and can be same or different for RACH and RACH-less handover procedures, or for subsequent RACH-less handover procedures in a same cell or in different cells.

A UE can receive in a SIB, from a source satellite or a source cell, information required for RACH-less handover procedure to a target satellite or a target cell, and the information can include a configuration of the target satellite for an uplink transmission, an SS/PBCH block index and/or time offset to detect the SS/PBCH block of the target satellite. After the UE detects the SS/PBCH block of the target satellite and acquires DL synchronization, the UE receives information in a SIB from the target satellite. The UE resets the N_TA value to 0 before an initial UL transmission, or sets the N_TA value according to a value provided by RRC, if configured. The initial UL transmission to the target satellite in a RACH-less handover procedure can be performed either using a dynamic uplink grant or, if configured, a configured uplink grant is pre-allocated by RRC.

For example, the source satellite provides information for more than one candidate satellite for the RACH-less handover procedure. The RACH-less handover signaling provided via RRC can include beam information (also referred as spatial setting information) and N_TA information for N candidate satellites, and the UE selects a target satellite from the N candidate satellites, determines a target beam and a target N_TA value corresponding to the target satellite and associated target cell from the configuration, monitors PDCCH for reception of a DCI format including a dynamic grant for a PUSCH transmission using the target beam, and transmits the PUSCH using the target beam and the target N_TA.

For example, the UE can receive configurations for N candidate satellites, and for each of the N candidate satellites receive an SS/PBCH block index and/or time offset. The UE can perform measurements based on the SS/PBCH block from candidate satellites, and select a target satellite from the N candidate satellites for RACH-less handover procedure based on the measurements being larger than an RSRP threshold, if configured. For all the N candidate satellites, subject to the RACH-less configuration, the initial uplink transmission of the RACH-less handover procedure to the target satellite would be performed either using a dynamic uplink grant or a configured uplink grant configured by RRC. It is possible that for some of the N candidate satellites, the initial uplink transmission of the RACH-less handover procedure would be performed using a dynamic uplink grant and for some other of the N candidate satellites, the initial uplink transmission of the RACH-less handover procedure would be performed using a configured uplink grant configured by RRC.

In one sub-example, the UE selects a first candidate satellite for which the initial uplink transmission for initiating a first RACH-less handover procedure would be performed using a dynamic grant, and in case the first RACH-less handover procedure is not successful, the UE selects a second candidate satellite for which the initial uplink transmission would be performed using a dynamic grant, if configured. The UE would select candidate satellites configured with UL dynamic grant for first and subsequent attempts to perform RACH-less handover.

In one sub-example, the initial uplink transmission for initiating a first RACH-less handover procedure is configured without dynamic grant, and a UE uses a configured UL grant configured via RRC or provided via a PDCCH.

In one sub-example, a UE is provided information for RACH-less handover for multiple candidate satellites and initial uplink transmissions are configured with dynamic grant for a first set of candidate satellites and with configured grant for a second set of candidate satellites. The UE can be provided a first RRC parameter including information for RACH-less handover procedure with initial transmissions with dynamic grant for the first set of candidate satellites and a second RRC parameter including information for RACH-less handover procedure with initial transmissions with configured grant.

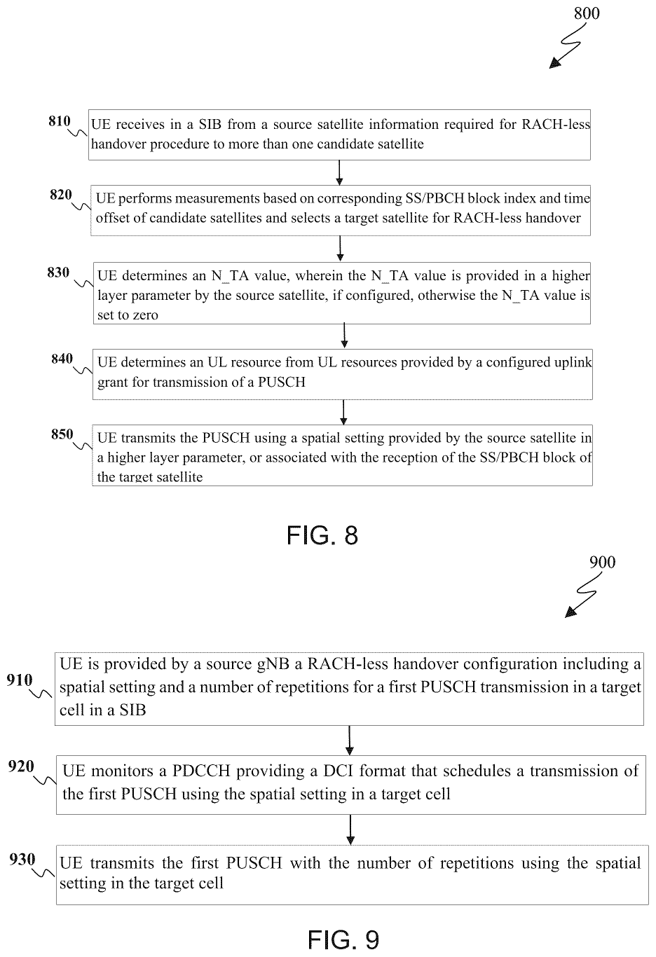

FIG. 8 illustrates a UE procedure 800 for RACH-less handover to a target satellite according to various embodiments of the present disclosure. The procedure 800 of FIG. 8 can be performed by any of the UEs 111-116 of FIG. 1, such as the UE 116 of FIG. 3. The procedure 800 of FIG. 8 is for illustration only and other embodiments can be used without departing from the scope of the present disclosure.

The procedure 800 begins with a UE receiving in a SIB from a source satellite information required for RACH-less handover procedure to more than one candidate satellite, and additionally receives SS/PBCH block index and time offset for each candidate satellite 810. The UE performs measurements based on corresponding SS/PBCH block index and time offset of candidate satellites and selects a target satellite for RACH-less handover 820. The UE determines an N_TA value, wherein the N_TA value is provided by a higher layer parameter by the source satellite, if configured, otherwise the N_TA value is set to zero 830. The UE determines an UL resource from UL resources provided by a configured uplink grant for transmission of a PUSCH 840. The UE transmits the PUSCH in the determined UL resource using a spatial setting provided by the source satellite in a higher layer parameter, and/or associated with (the reception of) an SS/PBCH block of the target satellite 850. Alternatively to 820, the UE performs measurements based on corresponding SS/PBCH block indexes and time offsets of candidate satellites and reports the measurements to the source satellite that triggers the RACH-less handover procedure for a first target satellite from the candidate satellites using a MAC CE or RRC signaling. It is possible that the determination of the target satellite is done at the source satellite or at the corresponding source gNB on the ground.

Similar to the RACH-less handover procedure of FIG. 8, a UE can switch from a source cell to a target cell, wherein the source and target cells cover areas that are both within a satellite footprint. The source cell is associated with a source beam and the target cell is associated with a target beam. The UE can receive information required for RACH-less handover procedure to the target cell by RRC signaling, and also receive information of the target beam to use for the first UL transmission in the target cell. The beam information can be provided by the RACH-less RRC parameter or by a MAC CE. The triggering of the RACH-less handover procedure can be indicated by a MAC CE.

A RACH-less handover procedure is assumed successfully completed when a target gNB indicates completion of the RACH-less procedure by providing HARQ-ACK information for the transport block of an initial transmission by the UE in the target cell, and the UE assumes that the transport block was correctly decoded if the HARQ-ACK information value is ACK; otherwise, the UE assumes that the transport block was not correctly decoded. It is possible that the target gNB does not provide the HARQ-ACK information for the transport block of an initial transmission by the UE in the target cell, and sends a PDSCH scheduled by a PDCCH. In response to the reception of the PDSCH the UE transmits a PUCCH with HARQ-ACK information. Upon transmission of the PUCCH, the RACH-less handover is assumed completed and upper layers can be notified.

When a UE (e.g., UE 114) is provided a configuration for a RACH-less HO, in order to improve a reception reliability at a target gNB (e.g., gNB 102) of a PUSCH transmitted by the UE while the UE is in RRC_CONNECTED state in a source cell, wherein the PUSCH is scheduled by an UL grant in the RACH-less HO configuration provided by the source gNB or in a DCI format transmitted by the target gNB, the UE can transmit the PUSCH to the target gNB with repetitions. The UE can also transmit to a target gNB a PUCCH with repetitions, wherein the PUCCH provides an HARQ-ACK information in response to a PDSCH reception before receiving information by UE-specific RRC signaling for PUCCH resources with repetitions.

Therefore, there is a need to indicate to a UE a number of repetitions for a PUSCH transmission during for a RACH-less HO procedure. There is another a need to indicate to the UE a number of repetitions for a PUCCH transmission when the UE is not provided PUCCH resources by UE-specific RRC signalling during for the RACH-less HO, or for the first PUCCH transmission after the first PUSCH transmission in the target cell.

When a UE (e.g., UE 114) is configured with a RACH-less HO by a source gNB, the UE can be provided an UL grant for transmission of a PUSCH to the target gNB in the RACH-less HO configuration, and the transmission can correspond to a configured grant Type 1 that is semi-statically configured to operate upon the reception of higher layer parameters without the detection of an UL grant in a DCI. The UE receiving the RACH-less configuration is in connected state in the source cell, and it is assumed that if the UE is capable of transmitting Msg3 PUSCH with repetitions during a 4-step RA procedure or is capable of transmitting MsgA PUSCH with repetitions during a 2-step RA procedure, the UE is also capable of transmitting the PUSCH configured for a RACH-less HO with repetitions. The RACH-less HO configuration can include a value for a number of repetitions for the configured PUSCH transmission, or can include more than one values, and the UE can determine which value to use based on RSRP measurements, or based on RSRP measurements and an RSRP threshold provided in the RACH-less HO configuration. It is possible that when multiple values for the number of repetitions are provided, a first value is used for a first PUSCH transmission and a second value is used for a second PUSCH transmission in case the first transmission attempt is not successful. For example, a UE can be configured with more than one UL grants, and for each UL grant the UE can be provided a number of repetitions which can be same or different than the number of repetitions associated to another UL grant, or the UE can be provided a single value for the number of repetitions that is associated with all the configured UL grant.

In embodiments, the UE (e.g., UE 114) is also provided in the RACH-less configuration a spatial setting information for transmission of the PUSCH with repetitions. For example, the UE can be provided a first spatial setting associated with a first configured UL grant and a first number of repetitions, and a second spatial setting associated with a second configured UL grant and a second number of repetitions, and the UE transmits the PUSCH repetitions using the corresponding configured spatial setting. In embodiments, the spatial setting information is associated with first and second UL grant, and in case the first PUSCH transmission corresponding to the first UL grant is not successful, the UE transmits the second PUSCH transmission corresponding to the second UL grant using the same spatial setting. When the UE is provided multiple UL grants, the association of the multiple grants with same or different number of repetitions or same or different spatial settings can be different. In a first example, a same spatial setting is used over a time interval that can include multiple PUSCH transmissions associated with corresponding multiple UL grants and each PUSCH transmission is with a corresponding number of repetitions. In a second example, a same number of repetitions is used over a time interval that can include multiple PUSCH transmissions associated with corresponding multiple UL grants and each PUSCH transmission is with a corresponding spatial setting.

When a UE (e.g., UE 114) is configured with a RACH-less HO by a source gNB and the UE is not provided an UL grant for transmission of a PUSCH to the target gNB in the RACH-less HO configuration, the UE monitors a PDCCH from the target cell that includes an UL grant for a PUSCH transmission. The PUSCH transmission can be scheduled with repetitions, and the number of repetitions can be included in the scheduling DCI format, or the DCI format can include a field that provides a row index of a table that provides the number of repetitions. It is possible that for a RACH-less procedure in an NTN, the number of repetitions is included in the RACH-less HO configuration and the UL grant is not included in the RACH-less HO configuration. When the UE (e.g., UE 114) receive the UL grant from the target gNB, the UE transmits the PUSCH with the configured number of repetitions. It is possible that the UE indicates the number of repetitions used for the PUSCH transmission to the target gNB. The UE can use a 2-bit field to indicate one of four possible values that are configured in a SIB, or uses a 1-bit field to indicate one of two possible value, or uses a 1-bit field to indicate whether the PUSCH is with or without repetitions, and if the PUSCH is transmitted with repetitions, the value can be a predetermined value or configure in a SIB. It is also possible that when a UE is configured with RACH-less HO in NTN, and the UL grant is provided in a PDCCH received from the target gNB, the PUSCH is transmitted with repetitions, and the number of repetitions can be a predetermined number, or a number configured in a SIB, or provided in the RACH-less HO configuration, or provided in an NTN configuration.

FIG. 9 illustrates a UE procedure 900 for RACH-less handover for a first uplink transmission with repetitions scheduled by a DCI format received in a target cell according to various embodiments of the present disclosure. The UE procedure 900 of FIG. 9 can be performed by any of the UEs 111-116 of FIG. 1, such as the UE 116 of FIG. 3. The procedure 900 of FIG. 9 is for illustration only and other embodiments can be used without departing from the scope of the present disclosure.

The procedure 900 begins with the UE being provided, by a source gNB, a RACH-less handover configuration including a spatial setting and a number of repetitions for a first PUSCH transmission in a target cell in a SIB 910. The UE monitors a PDCCH providing a DCI format that schedules a transmission of the first PUSCH using the spatial setting in a target cell 920. The UE transmits the first PUSCH with the number of repetitions using the spatial settings in the target cell 930.

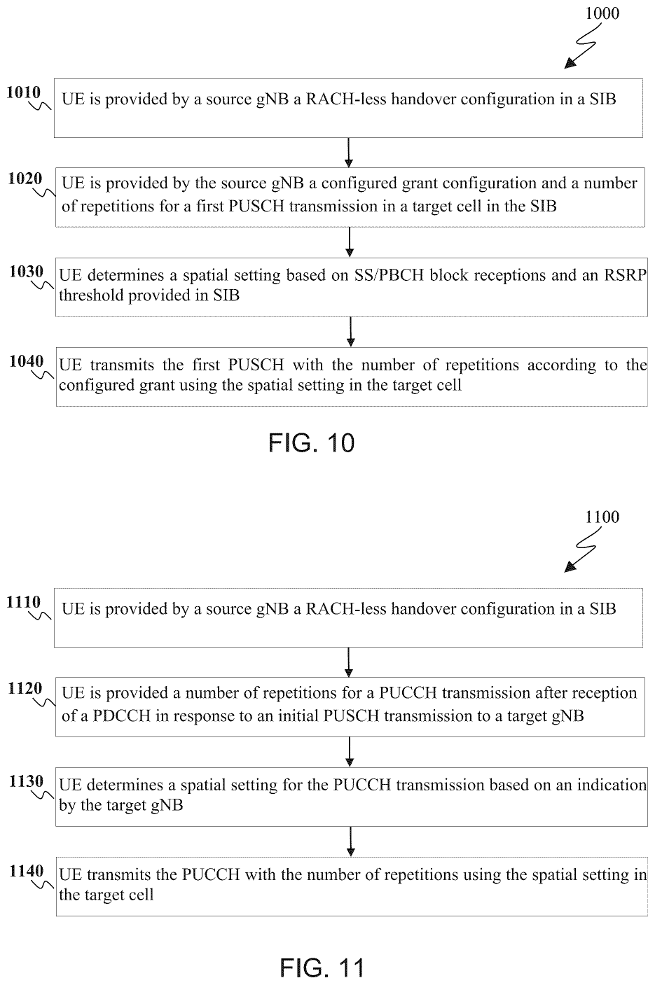

FIG. 10 illustrates a UE procedure 1000 for RACH-less handover for a first uplink transmission with repetitions in a target cell scheduled by a configured grant according to various embodiments of the present disclosure. The UE procedure 1000 of FIG. 10 can be performed by any of the UEs 111-116 of FIG. 1, such as the UE 116 of FIG. 3. The procedure 1000 of FIG. 10 is for illustration only and other embodiments can be used without departing from the scope of the present disclosure.

The procedure 1000 begins with the UE being provided, by a source gNB, a RACH-less handover configuration in a SIB 1010. The UE is provided by the source gNB a configured grant configuration and a number of repetitions for a first PUSCH transmission in a target cell in the SIB 1010. The UE determines a spatial setting based on SS/PBCH block receptions and an RSRP threshold provided in SIB 1020. The UE transmits the first PUSCH with the number of repetitions according to the configured grant using the spatial setting in the target cell 1040.

When a UE is configured with a RACH-less HO procedure by a source gNB and is configured to transmit an initial PUSCH with K repetitions over a number of slots on a target cell, the UE can be also configured with AvailableSlotCounting enabled. The UE then would transmit the initial PUSCH repetitions over the number of slots, and a slot is not counted in the number of K slots for the initial PUSCH transmission with repetitions if at least one of the symbols of the PUSCH transmission in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst.

When a UE is configured with a RACH-less HO procedure by a source gNB and is configured to transmit an initial PUSCH with K repetitions over a number of slots on a target cell, the UE can be also configured with pusch-DMRS-Bundling enabled, and procedures in TS 38.214 v18.1.0, clause 6.1.7, apply to the initial PUSCH transmission with repetitions on the target cell.

A UE (e.g., UE 114) operating in NTN and configured with a RACH-less HO can transmit a PUCCH that is a first PUCCH transmission on a target cell, and the PUCCH with HARQ-ACK information using resources that are indicated by a SIB, such as when the PUCCH transmission is prior to the UE establishing a dedicated RRC connection with a target cell, or prior to the UE receiving dedicated PUCCH resources while in RRC_connected state.

When a UE (e.g., UE 114) is configured with a RACH-less HO by a source gNB and the UE is provided an UL grant for transmission of a PUSCH to the target gNB in the RACH-less HO configuration or in a PDCCH from the target cell, and is configured with NTN operation, the UE can transmit a PUCCH with HARQ-ACK information when the UE is not provided PUCCH resources by UE-specific RRC signalling with repetitions, and the number of repetitions can be provided in a system information block (SIB) or, when the PUCCH transmission provides HARQ-ACK information associated with a DCI format, wherein the DCI format schedules a PDSCH reception and the PUCCH with HARQ-ACK is in response to the PDSCH reception, can be also indicated by the DCI format. The indication can be based on a separate field in the DCI format that indicates a number of repetitions for the PUCCH transmission or can be included in the configuration of PUCCH resources and a PUCCH resource can be indicated by the DCI format. In addition to parameters such as a PUCCH format, a starting symbol and a number of symbols, or a starting RB and a number of RBs, a PUCCH resource can also include a number of repetitions for a PUCCH transmission using the PUCCH resource. In embodiments, the UE (e.g., UE 114) is indicated by a MAC CE in a PDSCH reception to transmit a PUCCH with HARQ-ACK information with repetitions. Different types of MAC CEs may be used to indicate transmission of PUCCH with repetitions for a RACH-less RA procedure and a Type-1 or Type-2 RA procedure. In embodiments, the PUCCH is transmitted with repetitions if the PUSCH transmission, based on the configured UL grant in the RACH-less HO configuration or on the UL grant received in a PDCCH from the target cell, is transmitted with repetitions, and the same number of repetitions can be used for the PUSCH and the PUCCH unless a number of repetitions for PUCCH repetitions is provided.

The UE (e.g., UE 114) can transmit the PUCCH with the same spatial setting used for the transmission of the PUSCH, or can receive an indication from the target gNB to use a different spatial setting. It is possible that the UE transmits the PUCCH with the same spatial setting used for the transmission of the PUSCH, and in case the transmission of the PUSCH is not successful and the target gNB schedules a retransmission, the target gNB indicates a new spatial setting to use for the retransmission of the PUSCH in the DCI format that schedules the retransmission and for the transmission of a first PUCCH after the PUSCH transmission.

FIG. 11 illustrates a UE procedure for RACH-less handover for a first or initial PUCCH transmission with repetitions in a target cell according to various embodiments of the present disclosure. The UE procedure of FIG. 10 can be performed by any of the UEs 111-116 of FIG. 1, such as the UE 116 of FIG. 3. The procedure of FIG. 10 is for illustration only and other embodiments can be used without departing from the scope of the present disclosure.

A UE is provided by a source gNB a RACH-less handover configuration in a SIB 1110. The UE is provided a number of repetitions for a PUCCH transmission after reception of a PDCCH in response to an initial PUSCH transmission to a target gNB 1120. The UE determines a spatial setting for the PUCCH transmission based on an indication by the target gNB 1130. The UE transmits the PUCCH with the number of repetitions using the spatial setting in the target cell 1140. Alternatively, in step 1130 the UE determines the spatial setting for the PUCCH transmission based on an indication by the source gNB and the spatial setting is same as the spatial setting for the initial PUSCH transmission in the RACH-less handover procedure. It is possible that the indication of the spatial setting by the target gNB is provided by RRC signaling, or by a MAC CE, or by a dynamic signaling. For example, the spatial setting indication can be included in a DCI format of a PDCCH received after transmission of the first PUSCH, or in a PDSCH scheduled by the DCI format of the PDCCH. It is also possible that the spatial setting is determined by UE measurements of common signaling received from the target gNB, such as SS/PBCH blocks, or based on receptions of reference signals, such as CSI-RS, from the target gNB, and used for the initial PUSCH transmission and the PUCCH transmission.

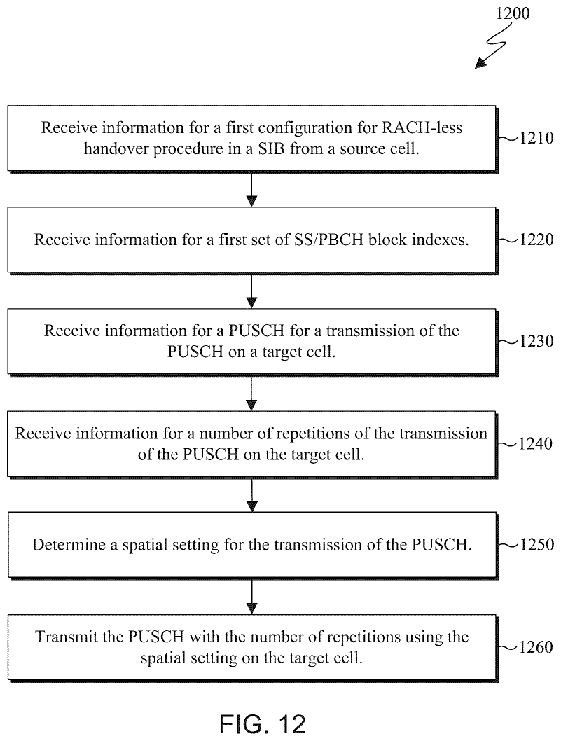

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE receiving information for a first configuration for RACH-less handover procedure in a SIB from a source cell (1210). The UE also receives information for a first set of SS/PBCH block indexes (1220). The UE also receives information for a PUSCH for a transmission of the PUSCH on a target cell (1230). The UE also receives receive information for a number of repetitions of the transmission of the PUSCH on the target cell (1240). For example, in 1210-1240, the UE may receive the information together in the same signals or channels or in separate signals or channels.

The UE then determine a spatial setting for the transmission of the PUSCH (1250). The UE then transmits the PUSCH with the number of repetitions using the spatial setting on the target cell (1260).

In various embodiments, the UE receives, from the source cell, information for a second configuration for the transmission of the PUSCH, which is a configured grant PUSCH, and a mapping between the first set of SS/PBCH block indexes and PUSCH transmission occasions. The UE then determines, based on the mapping, a first PUSCH transmission occasion from the PUSCH transmission occasions when the number of repetitions is one or one or more first PUSCH transmission occasions from the PUSCH transmission occasions when the number of repetitions is larger than 1. Here, the one or more first PUSCH transmission occasions are associated with an SS/PBCH block index according to the mapping. The UE then transmits the configured grant PUSCH in the one or more first PUSCH transmission occasions on the target cell.

In various embodiments, the SIB further provides information for a first RSRP value and the UE determines a RSRP value associated with a reception of an SS/PBCH block associated with the first set of SS/PBCH block indexes, that the RSRP value is larger than or equal to the first RSRP value, and the spatial setting based on the RSRP value. In various embodiments, the UE receives more than one second configuration for the transmission of the PUSCH. In various embodiments, the SIB further provides information for a second set of SS/PBCH block indexes and the second set of SS/PBCH block indexes is included in the first set of SS/PBCH block indexes.

In various embodiments, the SIB further provides information for a first SS/PBCH block index and the UE determines the spatial setting for the transmission of the PUSCH based on the first SS/PBCH block index and receive, from the target cell, using the spatial setting, a PDCCH providing a DCI format that schedules the transmission of the PUSCH.

In various embodiments, the UE receives information for a first spatial setting and a second spatial setting from higher layers and receives, using the first spatial setting, a PDCCH providing a DCI format that schedules the transmission of the PUSCH. Here, the spatial setting used for transmission of the PUSCH is the second spatial setting.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

1. A user equipment (UE) comprising:
a transceiver configured to receive information for:
a first configuration for random access channel (RACH)-less handover procedure in a system information block (SIB) from a source cell,
a first set of synchronization signal (SS) and physical broadcast channel (PBCH) (SS/PBCH) block indexes,
a physical uplink shared channel (PUSCH) for a transmission of the PUSCH on a target cell, and
a number of repetitions of the transmission of the PUSCH on the target cell; and
a processor operably coupled to the transceiver, the processor configured to determine a spatial setting for the transmission of the PUSCH,
wherein the transceiver is further configured to transmit the PUSCH with the number of repetitions using the spatial setting on the target cell.

2. The UE of claim 1, wherein:
the transceiver is further configured to receive, from the source cell, information for:
a second configuration for the transmission of the PUSCH, wherein the PUSCH is a configured grant PUSCH, and
a mapping between the first set of SS/PBCH block indexes and PUSCH transmission occasions;
the processor is further configured to determine, based on the mapping, one of:
a first PUSCH transmission occasion from the PUSCH transmission occasions when the number of repetitions is one, or
one or more first PUSCH transmission occasions from the PUSCH transmission occasions when the number of repetitions is larger than 1, wherein the one or more first PUSCH transmission occasions are associated with an SS/PBCH block index according to the mapping; and
the transceiver is further configured to transmit the configured grant PUSCH in the one or more first PUSCH transmission occasions on the target cell.

3. The UE of claim 2, wherein:
the SIB further provides information for a first reference signal received power (RSRP) value; and
the processor is further configured to determine:
a RSRP value associated with a reception of an SS/PBCH block associated with the first set of SS/PBCH block indexes,
that the RSRP value is larger than or equal to the first RSRP value, and
the spatial setting based on the RSRP value.

4. The UE of claim 2, wherein:
the SIB further provides information for a second set of SS/PBCH block indexes, and
the second set of SS/PBCH block indexes is included in the first set of SS/PBCH block indexes.

5. The UE of claim 1, wherein the transceiver is further configured to receive, from the target cell, a physical downlink control channel (PDCCH) providing a downlink control information (DCI) format that schedules the transmission of the PUSCH if a configuration for the transmission of the PUSCH with configured grant is not provided.

6. The UE of claim 1, wherein:
the SIB further provides information for a first SS/PBCH block index;
the processor is further configured to determine the spatial setting for the transmission of the PUSCH based on the first SS/PBCH block index; and
the transceiver is further configured to receive, from the target cell, using the spatial setting, a physical downlink control channel (PDCCH) providing a downlink control information (DCI) format that schedules the transmission of the PUSCH.

7. The UE of claim 1, wherein:
the transceiver is further configured to:
receive information for a first spatial setting and a second spatial setting from higher layers, and
receive, using the first spatial setting, a physical downlink control channel (PDCCH) providing a downlink control information (DCI) format that schedules the transmission of the PUSCH, and
the spatial setting used for transmission of the PUSCH is the second spatial setting.

8. A base station (BS) comprising:
a transceiver configured to transmit information for:
a first configuration for random access channel (RACH)-less handover procedure in a system information block (SIB) from a source cell,
a first set of synchronization signal (SS) and physical broadcast channel (PBCH) (SS/PBCH) block indexes,
a physical uplink shared channel (PUSCH) for a reception of the PUSCH on a target cell, and
a number of repetitions of the reception of the PUSCH on the target cell; and
a processor operably coupled to the transceiver, the processor configured to determine a spatial setting for the reception of the PUSCH,
wherein the transceiver is further configured to receive the PUSCH with the number of repetitions using the spatial setting on the target cell.

9. The BS of claim 8, wherein:
the transceiver is further configured to transmit, from the source cell, information for:
a second configuration for the reception of the PUSCH, wherein the PUSCH is a configured grant PUSCH, and
a mapping between the first set of SS/PBCH block indexes and PUSCH reception occasions;
the processor is further configured to determine, based on the mapping, one of:
a first PUSCH reception occasion from the PUSCH reception occasions when the number of repetitions is one, or
one or more first PUSCH reception occasions from the PUSCH reception occasions when the number of repetitions is larger than 1, wherein the one or more first PUSCH reception occasions are associated with an SS/PBCH block index according to the mapping; and
the transceiver is further configured to receive the configured grant PUSCH in the one or more first PUSCH reception occasions on the target cell.

10. The BS of claim 9, wherein:
the SIB further provides information for a second set of SS/PBCH block indexes, and
the second set of SS/PBCH block indexes is included in the first set of SS/PBCH block indexes.

11. The BS of claim 8, wherein the transceiver is further configured to transmit a physical downlink control channel (PDCCH) providing a downlink control information (DCI) format that schedules the reception of the PUSCH if a configuration for the reception of the PUSCH with configured grant is not provided to the UE.

12. The BS of claim 8, wherein:
the SIB further provides information for a first SS/PBCH block index;
the processor is further configured to determine the spatial setting for the reception of the PUSCH based on the first SS/PBCH block index; and
the transceiver is further configured to transmit, from the target cell, using the spatial setting, a physical downlink control channel (PDCCH) providing a downlink control information (DCI) format that schedules the reception of the PUSCH.

13. The BS of claim 8, wherein:
the transceiver is further configured to:
transmit information for a first spatial setting and a second spatial setting from higher layers, and
transmit, using the first spatial setting, a physical downlink control channel (PDCCH) providing a downlink control information (DCI) format that schedules the reception of the PUSCH, and
the spatial setting used for reception of the PUSCH is the second spatial setting.

14. A method comprising:
receiving information for:
a first configuration for random access channel (RACH)-less handover procedure in a system information block (SIB) from a source cell,
a first set of synchronization signal (SS) and physical broadcast channel (PBCH) (SS/PBCH) block indexes,
a physical uplink shared channel (PUSCH) for a transmission of the PUSCH on a target cell, and
a number of repetitions of the transmission of the PUSCH on the target cell;
determining a spatial setting for the transmission of the PUSCH; and
transmitting the PUSCH with the number of repetitions using the spatial setting on the target cell.

15. The method of claim 14, further comprising:
receiving, from the source cell, information for:
a second configuration for the transmission of the PUSCH, wherein the PUSCH is a configured grant PUSCH, and
a mapping between the first set of SS/PBCH block indexes and PUSCH transmission occasions; and
determining, based on the mapping, one of:
a first PUSCH transmission occasion from the PUSCH transmission occasions when the number of repetitions is one, or
one or more first PUSCH transmission occasions from the PUSCH transmission occasions when the number of repetitions is larger than 1, wherein the one or more first PUSCH transmission occasions are associated with an SS/PBCH block index according to the mapping,
wherein transmitting the PUSCH with the number of repetitions using the spatial setting on the target cell further comprises transmitting the configured grant PUSCH in the one or more first PUSCH transmission occasions on the target cell.

16. The method of claim 15, wherein:
the SIB further provides information for a first reference signal received power (RSRP) value;
the method further comprises determining:
a RSRP value associated with a reception of an SS/PBCH block associated with the first set of SS/PBCH block indexes, and
that the RSRP value is larger than or equal to the first RSRP value; and
wherein determining the spatial setting for the transmission of the PUSCH further comprises determining the spatial setting based on the RSRP value.

17. The method of claim 15, wherein:
the SIB further provides information for a second set of SS/PBCH block indexes, and
the second set of SS/PBCH block indexes is included in the first set of SS/PBCH block indexes.

18. The method of claim 14, further comprising receive, from the target cell, a physical downlink control channel (PDCCH) providing a downlink control information (DCI) format that schedules the transmission of the PUSCH if a configuration for the transmission of the PUSCH with configured grant is not provided.

19. The method of claim 14, wherein:
the SIB further provides information for a first SS/PBCH block index;
determining the spatial setting for the transmission of the PUSCH further comprises determining the spatial setting for the transmission of the PUSCH based on the first SS/PBCH block index; and
the method further comprises receiving, from the target cell, using the spatial setting, a physical downlink control channel (PDCCH) providing a downlink control information (DCI) format that schedules the transmission of the PUSCH.

20. The method of claim 14, further comprising:
receiving information for a first spatial setting and a second spatial setting from higher layers; and
receiving, using the first spatial setting, a physical downlink control channel (PDCCH) providing a downlink control information (DCI) format that schedules the transmission of the PUSCH,
wherein the spatial setting used for transmitting the PUSCH is the second spatial setting.
